(19) United States
(12) Patent Application Publication
(10) Pub. No.: US 2024/0353273 A1
(43) Pub. Date: Oct. 24, 2024

(54) ELECTRICALLY CONDUCTIVE ASSEMBLY

(71) Applicant: David Lussey, Richmond (GB)

(72) Inventor: David Lussey, Richmond (GB)

(21) Appl. No.: 18/685,468

(22) PCT Filed: Aug. 19, 2022
(86) PCT No.: PCT/GB2022/052158

§ 371 Date: Feb. 21, 2024

(30) Foreign Application Priority Data
Aug. 21, 2021 (GB) 2112019.1

(51) Int. Cl. G01L 1/20; B32B 5/02; B32B 5/12; D02G 3/02; D03D 15/275; D04H 1/413; D04H 1/4242; D06M 11/49; D06M 101/40; G01L 1/14; H01B 5/08

(52) U.S. Cl. CPC G01L 1/205; B32B 5/024; B32B 5/12; D02G 3/02; D03D 15/275; D04H 1/413; D04H 1/4242; D06M 11/49; G01L 1/146; H01B 5/08; B32B 2262/106; B32B 2264/303; B32B 2307/202; B32B 2307/208; B32B 2457/00; D06M 2101/40; D10B 2401/16; D10B 2505/00

(57) ABSTRACT

An electrically anisotropic pressure sensitive assembly comprises a contained quantity of electrically conductive particles including first electrically conductive particles, which first electrically conductive particles are magnetite particles, wherein the quantity of magnetite particles includes a distribution of particle sizes between sub-micron and tens of microns. The magnetite particles have a plurality of planar faces, adjacent planar faces connected at a vertex, the particles each having a plurality of vertices wherein the magnetite particles are irregular in shape. The resistance and/or capacitance of the electrically conductive assembly changes in accordance with the pressure exerted thereon. The assembly includes at least two electrically conductive elements, the quantity of electrically conductive particles being contained in interstices between the at least two electrically conductive elements.

### CROSS-REFERENCE TO RELATED APPLICATION(S)

This application is the national phase of PCT Application No. PCT/GB2022/052158 filed on Aug. 19, 2022, which claims priority to British Application No. 2112019.1 filed on Aug. 21, 2021, both of which are incorporated by reference herein in their entireties.

### TECHNICAL FIELD

The present disclosure relates to electrically conductive assemblies, and in particular to electrically conductive assemblies comprising magnetite in conjunction with electrically conductive elements.

### BACKGROUND

It is known that composites comprising polymer binder matrixes containing quantities of magnetite particles with specific dimensions and morphology can demonstrate electrical conduction ranges which can be varied over many orders of change by the application of mechanical pressure or electrical voltage. The electrical and mechanical properties of the polymer component of the matrix are required to have a low level of electrical conductivity and preferably be an electrical insulator with a level of flexibility which allows it to deform under pressure and return to its start state when the pressure is removed. The matrix component would normally have a resistance of more than 109 ohms in its quiescent state to work as an effective insulating binder in these composites and the mobility of the polymer and its response to pressure when loaded with the magnetite particles is fundamental to the sensitivity of the composite's response to an applied force. Such composite materials have found use in sensors.

These sensors are described in the applicant's international patent application published under number WO 20171103592, which is incorporated herein by reference.

Also described in WO2017/103592 are electrically conductive compositions where the same magnetite particles are contained between spaced apart non-conductive elements instead of within a binder, for example, within a yarn, in interstices within a fabric, in pockets in a fabric or between layers of fabric.

In W02020/039216, which is incorporated herein by reference, the applicant described composite materials where magnetite particles as described above are held within different types of non-conductive binder, for example oils, gels, waxes, gel-waxes and gel-inks. In W02020/136373, which is incorporated herein by reference, the applicant described a method of controlling the electrical properties of magnetite particles by heating such particles in an oxygen rich environment for a period of time, and materials made from such heated magnetite. Also described in WO2020/136373 are composite materials containing magnetite for laying down as thin films.

Common to each of the applicant's above-mentioned applications is the use of a non-conductive binder, substrate or matrix (for example the non-conductive yarns and fabrics described in WO2017/103592).

Surprisingly, the applicant has found through experimentation that a combination of magnetite particles with a substrate and/or binder that is conductive can have utility in providing an electrically anisotropic response to pressure.

Carbon fiber composites are known for their strength and are often used in components of airplanes, vehicles and other structures. Carbon fiber composites are also known for their propensity to fail suddenly. Over time faults in carbon fiber materials may develop. For example, layers of carbon fiber within a composite may become delaminated, or internal cracks may develop due to repeated stress cycling, impacts or environmental degradation. If these faults are not detected, catastrophic failure may occur.

The applicant has found that incorporating magnetite particles into such electrically conductive composite material allows stresses to which the materials are subjected to be measured and monitored.

Furthermore, the electrically conductive elements of the composite material, for example carbon fibers in one or more ends of yarn in the warp or weft of a carbon fiber woven fabric can be used to transmit signals between a part of a composite material containing magnetite and a power supply and signal processor situated remotely.

Carbon fibers are typically available as rovings, which are bunches of carbon fibers that have not been woven, yarns, which are spun rovings, woven fabrics having ends of yarn in warp and weft, tows comprising unidirectional carbon fiber where the carbon fibers are aligned in one direction and are held together by occasional strands of either carbon or polyester running at 90 degrees across the fibers. Alternate sheets of unidirectional carbon fiber may be placed at angles to each other to provide different performance characteristics.

In this specification the terms, “yarn” and “thread” shall have the same meaning.

In this specification references to mixing in a low shear mixing regime means intimate mixing of the filler powder and the binder achieved with a low shear mixing regime for the shortest time needed to coat the individual powder particles. Mixing ends at that point to reduce possible aggregation of individual particles. Detection of the end point can be achieved by eye, that is observation by the person carrying out the mixing, whether the mixing is done using hand tools (such as a spatula) or powered tools, or by trial and experiment the end point may be correlated to a particular measurable parameter of a mixing machine, such as motor torque.

### SUMMARY

According to the present disclosure there is provided an electrically anisotropic pressure sensitive assembly, the assembly comprising a contained quantity of electrically conductive particles including first electrically conductive particles, which first electrically conductive particles are magnetite particles, wherein the quantity of magnetite particles includes a distribution of particle sizes between sub-micron and tens of microns, and wherein the magnetite particles have a plurality of planar faces, adjacent planar faces connected at a vertex, the particles each having a plurality of vertices wherein the magnetite particles are irregular in shape, the resistance and/or capacitance of the electrically conductive assembly changing in accordance with the pressure exerted thereon, and wherein the assembly includes at least two electrically conductive elements, the quantity of electrically conductive particles being contained in interstices between the at least two electrically conductive elements.

The change in resistance of the assembly in accordance with pressure exerted on electrically conductive assembly may be characterized by reduced resistance with increasing applied pressure and increasing resistance with reduced pressure.

The change in capacitance of the assembly in accordance with pressure exerted on electrically conductive assembly may be characterized by increased capacitance with increasing applied pressure and reduced capacitance with reduced pressure. The electrically conductive elements may comprise fibers within a yarn, roving or tow, the quantity of magnetite particles being contained between the electrically conductive fibers within the yarn, roving or tow.

The electrically conductive elements may comprise a plurality of yarns, roving or tows or layers of fabric, the quantity of magnetite particles are contained between adjacent yarns, roving or tows or layers of fabric.

The fabric may be a woven fabric and the quantity of magnetite particles is contained in interstices between adjacent yarns within the fabric or within individual yarns within the fabric.

The fabric may be non-woven and the quantity of magnetite particles may be contained in interstices within said non-woven fabric.

Advantageously, the electrically conductive elements comprise carbon fibers.

The electrically conductive yarn may be comprised wholly or partly of electrically conductive fibers.

The quantity of magnetite particles may be carried in a binder. Where the quantity of magnetite particles are carried in a binder the particles are mixed with the binder in a low shear mixing regime.

The binder is preferably one of: a moldable binder; a polymer binder, a gel, an oil, a wax, a gel-wax, a gel-ink; and ink or mixtures thereof.

The binder may be electrically conductive. The electrical conductivity of the electrically conductive elements may be provided by the binder. An electrically conductive binder allows electrically conductive elements that are not inherently conductive in themselves, such as glass fibers, to be made conductive by virtue of the electrically conductive binder.

Preferably, the shape of the first electrically conductive particles in the distribution fall under the particle shape definitions of, “oblate”, that is tabular, and/or “bladed”, that is a flat or elongated shape form.

Advantageously, the distribution of particle size of the first electrically conductive particles at d₅₀ is between: 50 and 75 micron; or 60 and 65 micron; or 20 and 25 micron; or 5 and 15 micron or is 10 micron.

The particle size of the first type of electrically conductive particles at d₅₀ may be sub-micron in size, for example the particle size distribution may be in the range of 5 nanometers to tens of microns and more with the particle size at at d₅₀ lying therebetween and preferably, the particle size distribution may be in the range of 5 nanometers to less than 1 micron, for example 5nanometers to 900 nanometers with the particle size at d₅₀ lying therebetween. Where the second type of electrically conductive particles are carbon nanotubes or graphene, the particles may be sub-nanometer in size at least on one dimension. For example, carbon nanotubes may have diameters in the region of 0.4 nanometers, whilst their length may be tens of nanometers. Typically, carbon nanotubes are between 1 and 10 nanometers in length and more typically around 5nanometers in length. Graphene platelets are typically in the order of 0.3 nanometers thick and have lateral dimensions of between 1 and 100 nanometers.

Preferably, the distribution of particle sizes between sub-micron and tens of microns in the quantity of magnetite particles includes sub-micron sized particles and particles that are tens of microns in size.

The electrically anisotropic pressure sensitive assembly may further comprise a second type of electrically conductive or semi-conductive particle of a different shape or material to the first electrically conductive particle.

The second type of electrically conductive or semi-conductive particle has one of the following shapes: void bearing, plate like, needle like and spherical.

The second type of electrically conductive or semi-conductive particle may be selected from the group comprising: silver; nickel; copper; iron; tin; zinc; titanium and their oxides or a core coated with conductive or semi-conductive materials, or carbon particles such as graphite, graphene, carbon nano-tubes, etc.

The particles of the second type may be in a distribution of particle sizes between sub-micron and tens of microns. The distribution of particles of the second type may include sub-micron sized particles and particles that are tens of microns in size.

The particle size of the second type of electrically conductive particles at d₅₀ may be between 10 and 15 micron.

The particle size of the second type of electrically conductive particles at d₅₀ may be sub-micron in size, for example the particle size distribution may be in the range of 5nanometers to tens of microns and more preferably, 5 nanometers to less than 1 micron, for example 5 nanometers to 900 nanometers.

Advantageously, the resistance reduces with increased applied pressure and increases with reduced applied pressure. More advantageously, the resistance of the composition decreases by more than one order of magnitude with increased applied pressure and increases towards a quiescent state represented by the underlying resistance of the electrically conductive elements as the applied pressure is reduced. Advantageously, the capacitance of the composition increases, preferably by more than one order of magnitude with increased applied pressure and decreases towards a quiescent state as the applied pressure is reduced.

According to a second aspect of the present disclosure, there is provided a sensor comprising a first pair of conductors situated to one side of a carbon composite structure and a second pair of conductors situated to another side of the structure, wherein the second pair of conductors are electrically anisotropic pressure sensitive assemblies according to the first aspect of the present disclosure.

A carbon composite structure may be a carbon fiber or carbon nano-tube composite structure for example.

According to a third aspect of the present disclosure, there is provided a control system comprising a power supply and signal processor, and a sensor according to the second aspect of the present disclosure, the signal processor arranged to apply a voltage across the first pair of conductors and to measure a current or resultant in the second pair of conductors.

Where a resultant is measured in the second pair of conductors, the resultant may be a voltage, current or capacitance.

A sensor may be configured to monitor a change in resistance, a change in capacitance or, in the case of a hybrid sensor, both resistance and capacitance.

### BRIEF DESCRIPTION OF THE DRAWINGS

In the Drawings, which illustrate preferred embodiments of the present disclosure, and are by way of example:

FIG. 1 is a schematic representation of a yarn according to the present disclosure;

FIG. 2 is a schematic representation of an embodiment of a first class of sensor according to the present disclosure;

FIG. 3 is a schematic representation of an embodiment of a second class of sensor according to the present disclosure;

FIG. 4 is a schematic representation of an embodiment of a third class of sensor according to the present disclosure;

FIG. 5 is a schematic representation of an embodiment of a fourth class of sensor according to the present disclosure;

FIG. 6 is a schematic representation of a first measuring arrangement according to the present disclosure;

FIG. 7 is a schematic representation of a measuring arrangement known in the art;

FIG. 8 is a schematic representation of an aircraft equipped with a control system according to the present disclosure; and

FIG. 9 is a micrograph of a sample distribution of magnetite particles.

### DETAILED DESCRIPTION

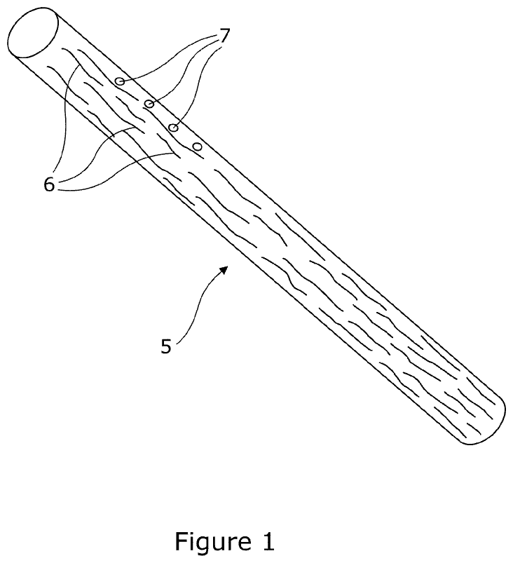

FIG. 1 illustrates a carbon fiber roving 5 which includes a multiplicity of individual carbon fibers 6 having magnetite particles 7 interspersed therebetween. The magnetite particles may be held in the roving 5 by electrostatic forces, without a binder, or a binder may be used to adhere the magnetite particles to the fibers.

The preferred type of magnetite particles are natural magnetite particles in a distribution of particle sizes. Such magnetite particles are available from LI<AB of Sweden. Alternatively, natural magnetite from New Zealand has been found to work in the present disclosure when comminuted and sized and sorted by sieving.

Table 1 below sets out four different types size distributions of magnetite available from LKAB.

TABLE 1

| Particle size | | | | Example 1 |
|---|---|---|---|---|
| distribution | Example 1 | Example 2 | Example 3 | Magnetite - |
| (cyclosizer | Magnetite - | Magnetite - | Magnetite - | Magnif |
| method) | Magnif 10 | Magnif 25 | Magnif 50 | EX014 |
| d10 (micron) | 5 | 6 | 9 | 3 |
| d50 (micron) | 10 | 22 | 63 | 7 |
| d90 (micron) | 25 | 50 | 180 | 13 |
| Particle | irregularly | irregularly | irregularly | irregularly |
| characteristics | shaped, low | shaped, low | shaped, low | shaped, low |
| | aspect ratio | aspect ratio | aspect ratio | aspect ratio |

The LKAB magnetite particles used may range in size between sub-micron and tens of microns at D50. The particles are produced by a pulverization process and have irregular shapes described as each having a plurality of planar faces, adjacent planar faces connected at a vertex, the particles each having a plurality of vertices.

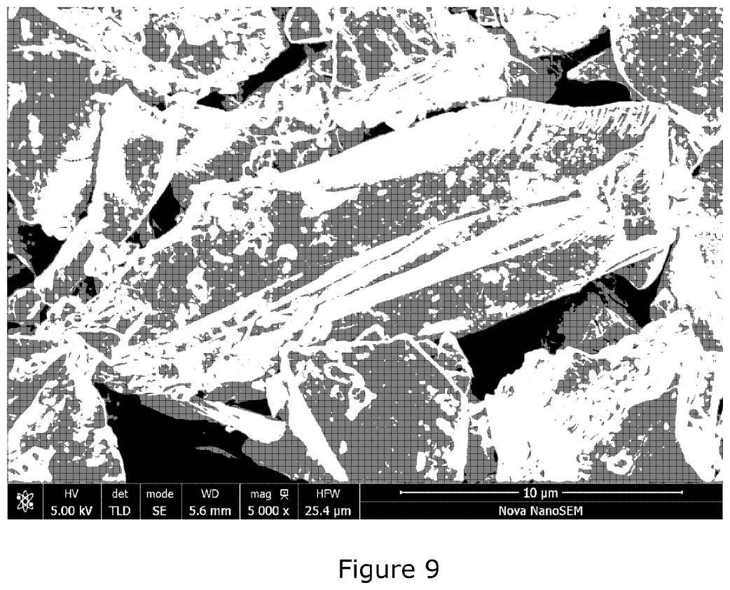

FIG. 9 is a micrograph of a sample distribution of the LKAB magnetite particles described above.

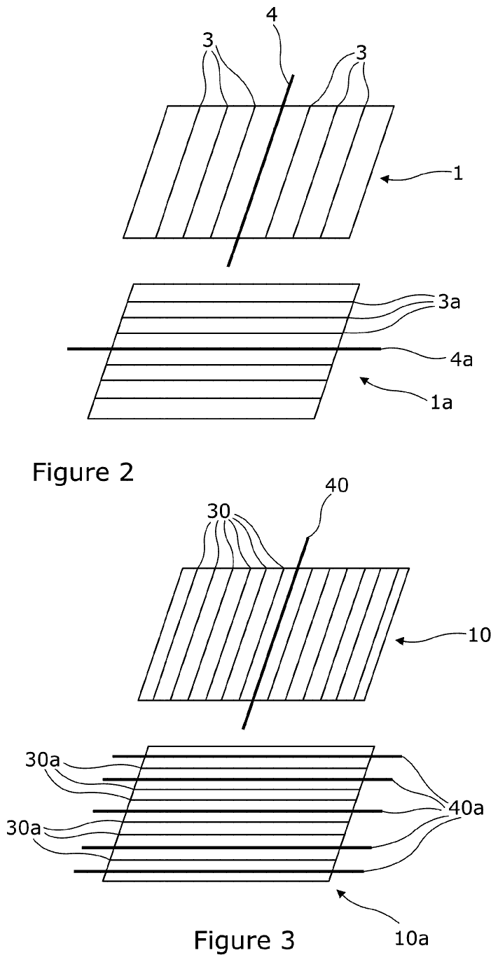

FIGS. 2 to 8 illustrate different embodiments of the present disclosure in which the matrix that magnetite particles are dispersed through is formed of electrically conductive material, such as carbon fibers. This embodiment allows sensors to be incorporated into structures which are often formed from carbon composite materials, such as aircraft structures, boat structures, etc. Carbon fiber has an inherent ability to conduct electricity. By loading the carbon 10 fiber with magnetite, a signal resulting from a change in resistance or capacitance when pressure is applied to the so loaded carbon fiber can be transmitted by the same or an adjacent carbon fiber yarn through which the magnetite is dispersed. An applied pressure may result from bending, stretching or twisting for example.

Carbon fiber composite materials are built up by laying layer upon layer of carbon fiber sheet, one on top of the other, typically with the orientation of individual carbon fiber threads being alternated, for example by 90 degrees from layer to layer. Resin is disposed between adjacent layers of carbon fiber sheet, bonding said sheets together. Reinforcement of specific areas may be made with carbon fiber rovings or tows.

One way to provide carbon fiber with magnetite is to load a yarn, roving or tow with magnetite particles by interspersing the magnetite particles within the yarn, roving or tow during the manufacturing process thereof. Magnetite particles will adhere to surfaces within the yarn, roving or tow due to electrostatic forces. Alternatively, the magnetite may be mixed with a binder, which may be applied to the yarn, roving or tow in the same way that fluids are applied to textiles in their manufacture. The application of fluids, such as oils, to textiles during their manufacture is well known in the art of textile manufacture.

Referring now to FIG. 2, a point sensor comprises a first layer of a woven carbon fiber textile sheet 1 which includes a plurality of parallel, spaced apart carbon fiber yarns 3. One carbon fiber yarn 4 is loaded with magnetite in the manner described above. A second layer of a woven carbon fiber textile sheet la includes a plurality of parallel, spaced apart carbon fiber yarns 3a. One carbon fiber yarn 4a is loaded with magnetite in the manner described above. When a force is exerted on one or both of the carbon fiber sheets 1, 1a at the point where the yarns 4, 4a cross, there and only there, a change in resistance and capacitance will occur. These electrical parameters can be sensed and/or measured by connecting the yarns 4 and 4a to suitable sensing/measuring apparatus.

FIG. 3 illustrates a line sensor. The line sensor comprises a first layer of a woven carbon fiber textile sheet 10, which includes a plurality of parallel, spaced apart carbon fiber yarns 30. One carbon fiber yarn 40 is loaded with magnetite in the manner described above. A second layer of a woven carbon fiber textile sheet 10a includes a plurality of parallel, spaced apart carbon fiber yarns 30a. A plurality of carbon fiber yarns 40a are loaded with magnetite in the manner described above. When a force is exerted on one or both of the carbon fiber sheets 10, 10a at one or more of the points where the yarn 40 crosses the yarns 40a, a change in resistance and/or capacitance will occur. These changes in resistance and capacitance can be sensed and/or measured by connecting the yarns 40 and 40a to suitable sensing/measuring apparatus.

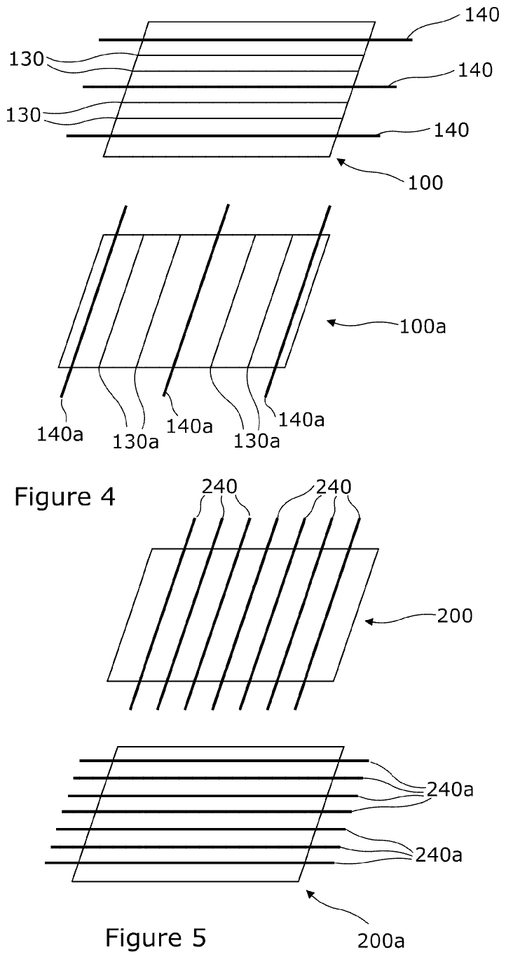

FIG. 4 illustrates a matrix sensor. The line sensor comprises a first layer of a woven carbon fiber textile sheet 100 includes a plurality of parallel, spaced apart carbon fiber yarns 130. A plurality of carbon fiber yarns 140 are loaded with magnetite in the manner described above. A second layer of a woven carbon fiber textile sheet 100a includes a plurality of parallel, spaced apart carbon fiber yarns 130a. A plurality of carbon fiber yarns 140a are loaded with magnetite in the manner described above. When a force is exerted on one or both of the carbon fiber sheets 100, 100a at any point where a yarn 140, crosses a yarn 140a a change in resistance and or capacitance will occur at the point of application of force. These changes in resistance and capacitance can be sensed and/or measured by connecting the yarns 140 and 140a to suitable sensing/measuring apparatus. This arrangement can identify not only applied forces, but also the location of those applied forces.

FIG. 5 illustrates an alternative matrix sensor, with finer resolution than that illustrated in FIG. 4. The line sensor comprises a first layer of a woven carbon fiber textile sheet 200, which includes a plurality of parallel, spaced apart carbon fiber yarns 240, each yarn 240 loaded with magnetite in the manner described above. A second layer of a woven carbon fiber textile sheet 200a includes a plurality of parallel, spaced apart carbon fiber yarns 240a, each yarn 240a loaded with magnetite in the manner described above. When a force is exerted on one or both of the carbon fiber sheets 200, 200a at the point where the yarns 240, 240a cross a change in resistance and or capacitance will occur at the point of application of force. These changes in resistance and capacitance can be sensed and/or measured by connecting the yarns 240 and 240a to suitable sensing/measuring apparatus.

Instead of providing two layers of fabric, each of which is unidirectional, as shown in FIGS. 2 to 5, in each case the two layers of unidirectional fabric may be replaced by a single layer of woven fabric. In the case of the FIG. 2 example, a woven fabric would comprise one carbon fiber yarn loaded with magnetite in the warp and weft respectively. In the FIG. 3 example, the woven fabric would comprise one carbon fiber yarns loaded with magnetite in the warp and five such yarns in the weft.

For the FIG. 4 example, woven fabric would comprise three carbon fiber yarns loaded with magnetite in the warp and weft respectively. For the FIG. 5 example, woven fabric would comprise seven carbon fiber yarns loaded with magnetite in the warp and weft respectively. As will be understood by the skilled person, the number and location of carbon fiber yarns loaded with magnetite can be specified according to what is to be monitored.

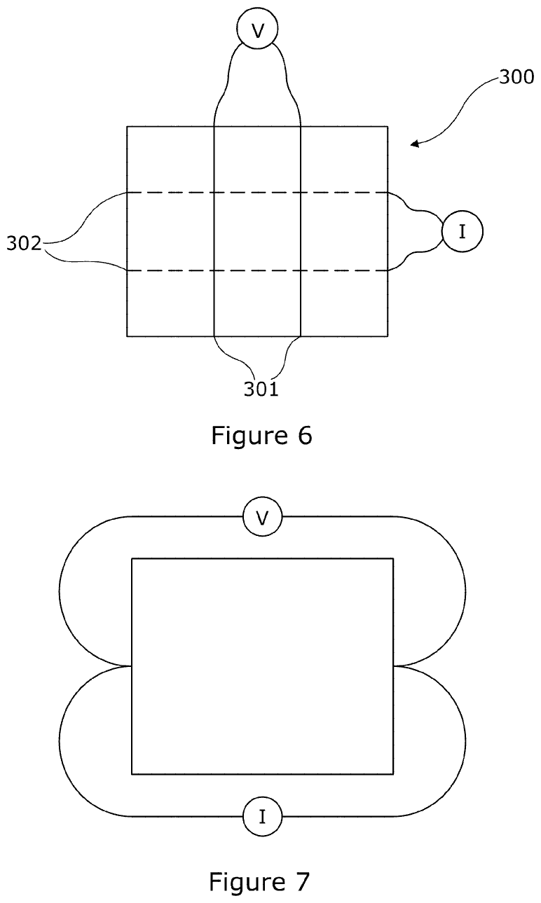

FIG. 6 illustrates another embodiment of the present disclosure utilizing carbon fiber yarns having magnetite dispersed between strands of carbon fiber within the yarn. In this embodiment a first pair of spaced apart carbon fiber yarns 301 having magnetite dispersed between strands of carbon fiber within the yarn is affixed to an upper surface of a carbon fiber composite panel 300. Affixed to the other side of the carbon fiber panel 300 is a second pair of carbon fiber yarns 302 (shown in broken lines) having magnetite dispersed between strands of carbon fiber within the yarn. The first and second pairs of carbon fiber yarns 301 and 302 lie orthogonal to one another. By applying a voltage (V) to the first pair of carbon fiber yarns 301 and measuring a current (I) in the carbon fiber yarns 302, the yarns 301 and 302 being spaced apart by the carbon fiber panel, the structural state of the carbon fiber panel 300 may be monitored. For example, with time or as a result of impacts, cracks or delamination in the carbon fiber panel 300 may occur, which would be reflected in a change in the measured current (I) or charge (C).

FIG. 7 illustrates the known method of monitoring carbon fiber panels for damage of the type described above. As can be seen, the carbon fiber panel is monitored simply by applying a voltage (V) across the carbon fiber panel and monitoring the current (I).

The monitoring arrangement illustrated in FIG. 6 provides for monitoring that is significantly more accurate than provided for by the arrangement illustrated in FIG. 7 due to the response of the carbon fiber yarns 301, 302 which are loaded with magnetite.

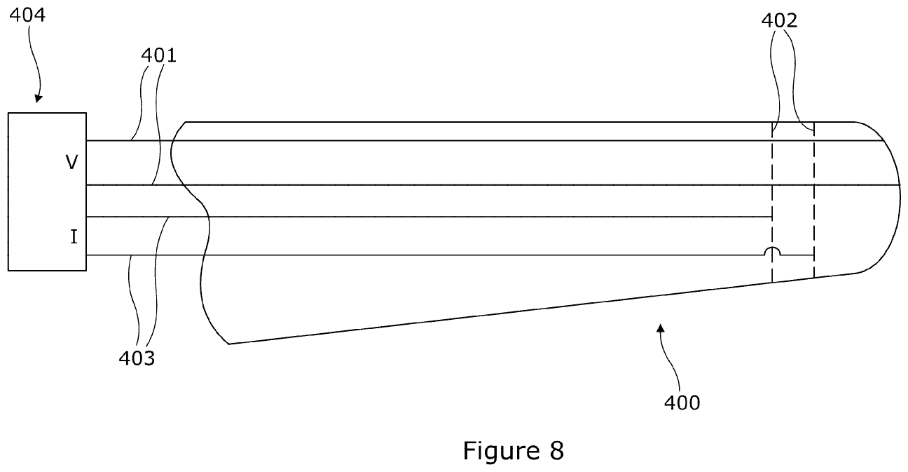

FIG. 8 illustrates the sensor arrangement illustrated in FIG. 6 configured for monitoring an aircraft wing 400. The aircraft wing is formed in carbon fiber composite material. Carbon fiber yarns 402 (shown in broken lines) loaded with magnetite in one of the manners described above are provided at one end of the wing 400 on one side of a layer of carbon fiber forming the wing 400. Carbon fiber yarns 401 which are not loaded with magnetite run from a power supply and signal processor unit 404 on board the aircraft to the magnetite loaded carbon fibers at the end of the wing on a spaced apart side of a layer of carbon fiber forming the wing 400. The carbon fibers 401 and 402 are hence spaced apart from each other by the layer or layers of carbon fiber between the carbon fiber yarns 401, 402. A second set of carbon fibers 403, again not loaded with magnetite, are situated on the same side of a layer of carbon fiber forming the wing 400 and run back to the power supply and signal processor unit 404. When a voltage (V) is applied across the carbon fiber yarns 401 a current (I) in the carbon fiber yarns 402 can be measured at the signal processor of the power supply and signal processor unit 404, the electrical current signal being returned to the power supply and signal processor unit 404 by carbon fiber yarns 403. If the structural state of the carbon fiber panel between the yarns 401 and 402, which are spaced apart by the carbon fiber panel, changes the current detected by the signal processor will change. This can be monitored over time to give an indication of the state of the monitored part of the wing 402. The same arrangement can be used to monitor stress changes in the wing 400 during flight.

The present disclosure brings the advantages of the applicant's earlier disclosures, referred to herein, to sectors where inherently conductive composites are used. The electrical properties of materials of the present disclosure move between the electrical properties of the underlying electrically conductive elements between which the magnetite is situated and the electrical properties of the magnetite, according to the pressure applied to the material. Furthermore, the underlying electrically conductive elements can be used to transfer signals to and 5 from the material of the present disclosure, in the case of a sensor for example.

1. An electrically anisotropic pressure sensitive assembly, the assembly comprising a contained quantity of electrically conductive particles including first electrically conductive particles, which first electrically conductive particles are magnetite particles, wherein a quantity of the magnetite particles includes a distribution of particle sizes between sub-micron and tens of microns, and wherein the magnetite particles have a plurality of planar faces, adjacent planar faces connected at a vertex, the magnetite particles each having a plurality of vertices wherein the magnetite particles are irregular in shape;
wherein the resistance and/or capacitance of the electrically conductive assembly changes in accordance with the pressure exerted thereon, and
wherein the assembly includes at least two electrically conductive elements, the quantity of electrically conductive particles being contained in interstices between the at least two electrically conductive elements.

2. An electrically anisotropic pressure sensitive assembly according to claim 1, wherein the electrically conductive elements comprise electrically conductive fibers within one of the group consisting of a yarn, roving and tow, the quantity of magnetite particles being contained between the electrically conductive fibers within the one of the group consisting of the yarn, roving and tow.

3. An electrically anisotropic pressure sensitive assembly according to claim 1, wherein the electrically conductive elements are selected from the group consisting of a plurality of yarns, rovings, tows, and layers of fabric, and the quantity of magnetite particles are contained between adjacent ones selected from the group consisting of yarns, rovings, tows and layers of fabric.

4. An electrically anisotropic pressure sensitive assembly according to claim 1, wherein the electrically conductive elements are comprised in a woven fabric and the quantity of magnetite particles is contained in interstices between adjacent yarns within the fabric or within individual yarns within the fabric.

5. An electrically anisotropic pressure sensitive assembly according to Claim 1, wherein the electrically conductive elements are comprised in a non-woven fabric and the quantity of magnetite particles is contained in interstices within said non-woven fabric.

6. An electrically anisotropic pressure sensitive assembly according to claim 1, wherein the electrically conductive elements are carbon fibers.

7. An electrically anisotropic pressure sensitive assembly according to any claim 1, wherein the electrically conductive elements comprise electrically conductive yarn comprised wholly or partly of electrically conductive fibers.

8. An electrically anisotropic pressure sensitive assembly according to claim 1, wherein the quantity of magnetite particles is carried in a binder.

9. An electrically anisotropic pressure sensitive assembly according to claim 8, wherein the binder is one selected from the group consisting of: a moldable binder, a polymer binder, a gel, an oil, a wax, a gel-wax, a gel-ink, an ink, and mixtures thereof.

10. An electrically anisotropic pressure sensitive assembly according to claim 9, wherein the binder is electrically conductive and wherein the electrical conductivity of the electrically conductive elements is provided by the binder.

11. An anisotropic pressure sensitive composition according to claim 1, wherein shapes of the first electrically conductive particles are oblate and/or bladed.

12. An electrically anisotropic pressure sensitive assembly according to claim 1, wherein the magnetite particles in the distribution have particle sizes of between 5 nanometers and 1000 nanometers.

13. An electrically anisotropic pressure sensitive assembly according to claim 1, wherein the distribution of particle size of the first electrically conductive particles at d₅₀ is one selected from the group consisting of: between 50 and 75 micron; between 60 and 65 micron; between 20 and 25 micron; between 5 and 15 micron; and 10 micron.

14. An electrically anisotropic pressure sensitive assembly according to claim 13, wherein the distribution of particle sizes between sub-micron and tens of microns in the quantity of magnetite particles includes sub-micron sized particles and particles that are tens of microns in size.

15. An electrically anisotropic pressure sensitive assembly according to claim 1, further comprising a second type of electrically conductive or semi-conductive particle of a different shape or material to the first electrically conductive particle.

16. An electrically anisotropic pressure sensitive assembly according to claim 15, wherein the particles of the second type are in a distribution of particle sizes between sub-micron and tens of microns.

17. An electrically anisotropic pressure sensitive assembly according to claim 16, wherein the distribution of particles of the second type includes sub-micron sized particles and particles that are tens of microns in size.

18. An electrically anisotropic pressure sensitive assembly according to claim 16, wherein particle size of the second type particle at d₅₀ is sub-micron in size.

19. An electrically anisotropic pressure sensitive assembly according to claim 15, wherein the size of the second type of particle in at least one dimension is one selected from the group consisting of: in the range of tenths of nanometers to tens of microns; 0.3 nanometers to less than 1 micron; and 5 nanometers to 900nanometers.

20. A sensor comprising a first pair of conductors situated to a first side of a carbon composite structure and a second pair of conductors situated to a second side of the carbon composite structure, wherein the second set of conductors are electrically anisotropic pressure sensitive assemblies, each of the electrically anisotropic pressure sensitive assemblies comprising a contained quantity of electrically conductive particles including first electrically conductive particles, which first electrically conductive particles are magnetite particles, wherein the quantity of magnetite particles includes a distribution of particle sizes between sub-micron and tens of microns, and wherein the magnetite particles have a plurality of planar faces, adjacent planar faces connected at a vertex, the particles each having a plurality of vertices wherein the magnetite particles are irregular in shape, the resistance and/or capacitance of the electrically conductive assembly changing in accordance with the pressure exerted thereon, and wherein the assembly includes at least two electrically conductive elements, the quantity of electrically conductive particles being contained in interstices between the at least two electrically conductive elements.

21. A sensor according to claim 20, wherein the carbon composite structure is a carbon fiber or carbon nano-tube composite structure.

22. A control system comprising a power supply and processor, and a sensor according to claim 20, the processor arranged to apply a voltage across the first pair of conductors and to measure a current or charge in the second pair of conductors.
